(19) United States
(12) Patent Application Publication
(10) Pub. No.: US 2014/0005911 A1
(43) Pub. Date: Jan. 2, 2014

(54) METHOD FOR ASCERTAINING A CYLINDER CHARGE OF AN INTERNAL COMBUSTION ENGINE ACHIEVABLE WITHIN A CERTAIN TIME PERIOD

(71) Applicants: Patrick MENOLD, Stuttgart (DE); Michael DRUNG, Muehlacker (DE); Rainer MAIER, Stuttgart (DE)

(72) Inventors: Patrick MENOLD, Stuttgart (DE); Michael DRUNG, Muehlacker (DE); Rainer MAIER, Stuttgart (DE)

(73) Assignee: ROBERT BOSCH GMBH, Stuttgart (DE)

(21) Appl. No.: 13/930,989

(22) Filed: Jun. 28, 2013

(30) Foreign Application Priority Data
Jun. 29, 2012 (DE) 10 2012 211 353.3

(51) Int. Cl. F02D 45/00

(52) U.S. Cl. CPC F02D 45/00
USPC 701/101

(57) ABSTRACT

A method for ascertaining a cylinder charge of an internal combustion engine of a vehicle achievable within a certain time period. In this case, a charging behavior of an air system, in particular of an intake manifold and of a charge air line, of the combustion engine is ascertained within the certain time period as a function of the instantaneous operating variables of the internal combustion engine, as well as of a dynamic of a final control element of the air system, in particular of a throttle valve. The cylinder charge achievable within the certain time period is ascertained as a function of the ascertained charging behavior of the air system and as a function of a charge buildup by a charger.

### CROSS REFERENCE

The present application claims the benefit under 35 U.S.C. §119 of German Patent Application No. DE 102012211353.3 filed on Jun. 29, 2012, which is expressly incorporated herein by reference in its entirety.

### FIELD

The present invention relates to a method for ascertaining a cylinder charge of an internal combustion engine achievable within a certain time period as well as a computer program set up for this purpose, an electronic storage medium, and an electronic control unit.

### BACKGROUND INFORMATION

Various torque variables are provided to the power train and to the ancillary units by the engine control unit for coordinating the load control. Presently, a stationary torque, which is maximally possible under the instantaneous boundary conditions, is provided as a variable by the engine control unit. The computation takes into account only static, instantaneous state variables, for example, but not the dynamic charging behavior of the air system or the charging system. Furthermore, a maximally admissible torque is ascertained which is influenced primarily by the component protection.

A device for automatically setting a clutch, which is situated in the drivetrain of a motor vehicle having a combustion engine, during the start-up and/or gear changing operation(s) is described in German Patent Application No. DE 196 16 960 C2 and includes an arrangement for determining the engine torque maximally achievable instantaneously under the assumption of the highest possible combustion torque control.

The engine torque instantaneously achievable at the maximum control of the fuel injection is a function of the instantaneous state variables such as speed, charging pressure, temperature, etc. The engine torque is supplied to a limiter which delimits the value to an admissible maximum value.

The use of maximally achievable stationary torques and an admissible maximum torque is problematic for many applications, since both values are only very unreliable indicators for what maximum torque is possible at a certain future point in time. In most cases, the maximally admissible torque is, for example, excessively high for this.

### SUMMARY

To ascertain a cylinder charge of an internal combustion engine maximally achievable within a certain time period, an example method is provided. Here, the dynamic charging behavior of the air system of the internal combustion engine is taken into account. In particular, the ascertainment of the achievable cylinder charge is a function of the maximum charging behavior which is predicted for the air system in the certain time period. The charging behavior is ascertained as a function of the dynamic of a final control element of the air system, in particular of a throttle valve in the intake manifold. The ascertainment takes place as a function of an instantaneous position of the final control element as well as of the retardation by the final control element opening completely. In addition, the ascertainment of the charging behavior is a function of the physical state variables of the air system or the internal combustion engine, e.g., the pressure variables such as charging pressure and intake manifold pressure. The cylinder charge achievable within the certain time period is additionally a function of what maximum charge a charging system (e.g., an exhaust-gas turbocharger), which is present in the internal combustion engine, is able to contribute.

The prediction or the computation of the cylinder charge maximally achievable during a certain time (or correspondingly the maximally achievable torque) allows this value to be used by the ascertaining unit (in particular by the engine control unit) for control or regulation or to be made available to other units (such as ancillary units or other control units) for controls or regulations. For many control or regulating processes, a statement is needed as to what maximum torque may occur during a certain control or regulation period. The variables which have been used previously to accomplish this, such as the stationary maximum torque or the maximally admissible torque, are unreliable variables in this conjunction. The instantaneously maximally achievable torque takes into account only statically the instantaneous state variables (e.g., the constant speed, the constant ambient variables) and interpolates for the case of a completely opened throttle valve. The maximally admissible torque is often times too large. In the case of low speeds in particular, the maximally admissible torque cannot even be achieved in the observed time period due to the starting conditions. Thus, a predicted maximum torque contributes to improving such control operations.

This dynamic, predicted torque corresponds here to the torque which would result at a certain future point in time if full load were required at the present point in time and the present engine state. With the aid of this variable, it is possible to improve the cooperation of various components in the vehicle. This relates, for example, to torque interventions, transmission interventions, or torque coordination between the electric machine and the internal combustion engine in hybrid systems.

A predicted, maximally achievable charge is preferably converted into a maximally achievable torque via the variables ignition angle efficiency and lambda efficiency. This allows most control units which are based on the variable torque to optimally use the ascertained value.

In one preferred variant, the certain time period for the prediction is selected as a function of a time which is needed by the control unit for the corresponding control or regulating interventions. In this way, the computed variable may be flexibly adjusted to the requirements of the corresponding control units. The time period may preferably correspond to the time needed therefor. In one alternative embodiment, a fixed time period may, however, also be predefined, whereby the modeling may be simplified and the computing may be carried out in a resources-saving and rapid manner.

In one preferred embodiment, the achievable torque is transmitted to a transmission control unit, in particular a dual-clutch transmission, which controls or regulates a switching operation as a function thereof. Here, the certain time period may in particular be a function of a time which is needed for a switching operation. By transmitting this torque variable, a particularly comfortable and smooth switching operation is enabled.

The ascertainment of the charging behavior of the air system preferably takes place as a function of a theoretical charge when the final control element is completely opened and an instantaneous charge is ascertained. The charge buildup of the charger may be ascertained as a function of a mass flow via the charger and an instantaneous pressure ratio at the charger, as a function of an ascertained engine speed as well as as a function of ascertained ambient variables, in particular an ambient pressure and ambient temperature.

The ascertainment preferably takes place in an engine control unit of the vehicle. The ascertainment also preferably takes place with the aid of a model stored as software in a memory of the engine control unit.

### BRIEF DESCRIPTION OF THE DRAWINGS

FIG. 1 shows a method for predicting a charging behavior of an air system.

FIG. 2 shows a method for predicting a maximally achievable cylinder charge.

### DETAILED DESCRIPTION OF EXAMPLE EMBODIMENTS

The present invention is illustrated schematically in the figures based on specific example embodiments and is described in greater detail below with reference to the figures.

The torque, which would result within a certain time interval if full load were required at the present point in time and the present engine state, is a valuable variable for various control and regulating processes. This torque of a combustion engine which is maximally achievable at a certain future point in time or within a certain future time period may be ascertained as a function of a cylinder charge maximally achievable until then. To predetermine such a cylinder charge, the dynamic of the air system is also taken into account starting from the ascertained instantaneous state variables of the combustion engine. For this purpose, the maximally achievable cylinder charge is determined as a function of the dynamic of a final control element of the air system (e.g., a throttle valve), of the dynamic of the charging behavior of the air system (e.g., the charging behavior of the intake manifold, the charge air line, or of the intake manifold and the charge air line) as well as of the dynamic of a charging of the air system (e.g., by a turbocharger).

When taking into account the dynamic of the final control element, it is preferably assumed that a final control element is opened completely at maximum speed starting from its instantaneous position. Moreover, a maximum contribution from a charging device of the air system is assumed. Starting from the ascertained instantaneous state of the air system or of the entire combustion engine (speed, pressure values, ambient variables), it is ascertained using these assumptions, preferably with the aid of a model stored in the engine control unit, or engine characteristic maps stored in the engine control unit, what maximum cylinder charge is achievable during a predefined time.

When the final control element is already completely opened, the maximally achievable cylinder charge is ascertained independently of a dynamic of the final control element and of a charging behavior of the air system associated with it. In this case, the ascertainment primarily takes place as a function of the charge buildup by the charging system. If, however, the throttle valve is completely or partially closed, the dynamic of the final control element, the dynamic charging behavior of the air system, as well as the dynamic charge buildup by the charger are to be seen as one entity.

The ascertainment of the dynamically maximally achievable cylinder charge, i.e., the predicted cylinder charge, preferably takes place in several stages. In a first stage, a charging behavior of the air system is ascertained as a function of a dynamic of a final control element of the air system (fast portions of the charge buildup), and in a second stage, the achievable cylinder charge is ascertained as a function of this charging behavior and of the charge buildup through the charging device of the air system (slow portions of the charge buildup).

In the first stage, the charging behavior of the air system (in particular of the intake manifold and of the charge air line) is ascertained. This ascertainment takes place independently of the dynamic portions of the charging device, but as a function of the dynamic of the final control element (in particular of the throttle valve) or the corresponding actuator (in particular of the throttle valve actuator). The ascertainment takes place as a function of multiple or all of the following physical variables: (ascertained instantaneous) charging pressure, (ascertained instantaneous) intake manifold pressure, (ascertained instantaneous) cylinder charge, theoretical charge with a completely opened final control element, (ascertained instantaneous) camshaft position, (ascertained instantaneous) engine guzzling behavior, (ascertained instantaneous) residual gas quantity in the cylinder. The residual gas quantity and the engine guzzling behavior may be ascertained as a function of the camshaft position in this case.

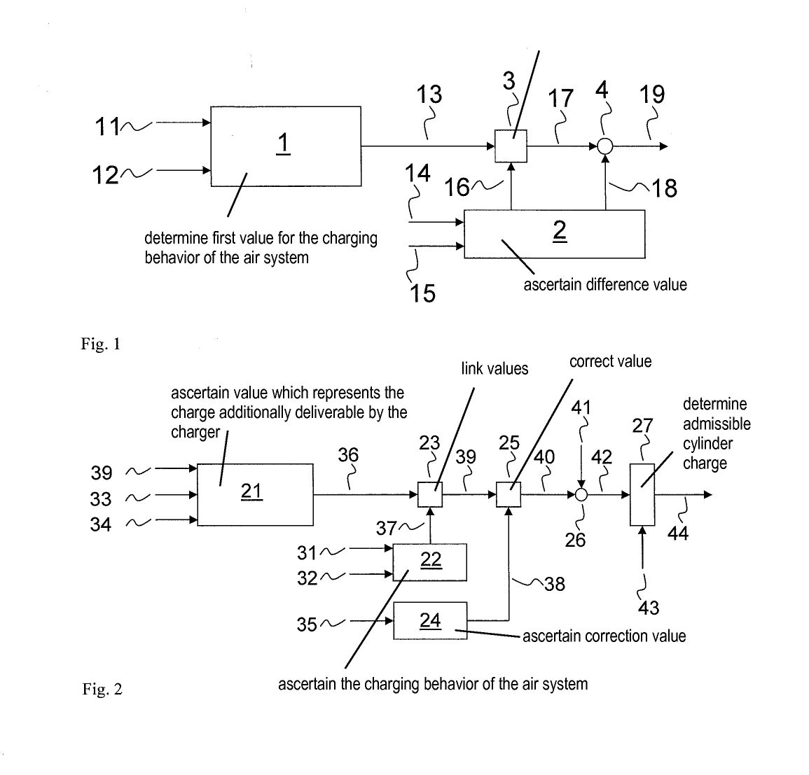

FIG. 1 schematically shows one preferred method for predicting a charging behavior of an air system, in particular of the intake manifold and the charge air line. In a first step 1, a first value 13 is determined for the charging behavior of the air system as a function of an ascertained instantaneous charging pressure 11 and an ascertained instantaneous intake manifold pressure 12. For this purpose, a ratio of intake manifold pressure 12 and charging pressure 11 is preferably formed and the dynamic of the final control element which corresponds to this ratio is determined on the basis of an engine characteristic map. Output value 13 thus corresponds to a factor which represents the retardation due to the opening process of the final control element. The certain time interval, for which the prediction of the achievable charge is to be ascertained, is preferably incorporated in this dynamic of the final control element. This may take place by the time value being fixedly applied, e.g., being based on the engine characteristic map, or by the time value being taken into account in a variable manner, e.g., the time value representing another dimension of the engine characteristic map.

In step 2, a value 16 is ascertained as a function of an ascertained instantaneous charge 14 and an ascertained theoretical charge 15 with the maximally opened final control element. Value 16 is in particular computed with the aid of the difference formation by subtracting instantaneous charge 14 from theoretical charge 15 in the maximally open state. If the throttle valve is opened completely, the resulting value is zero. As described above, the prediction is based in this case on the actual instantaneous charge value and the charge dynamic without the influence of the dynamic of the final control element. In step 3, difference value 16 is linked to the value for the dynamic 13 of the final control element, in particular by multiplication. The difference between actual charge 14 and possible charge 15 with a maximally opened final control element is also weighted in that it is not possible to open the final control element immediately, but a retardation takes place due to the opening process. Value 17 ascertained therefrom is linked to value 18 in step 4. Value 18 is in this case a value which is a function of actual charge 14, [and] preferably equal to actual charge 14. The linkage in step 4 is preferably an addition. Initial value 19 thus represents the charging behavior of the air system as a function of the dynamic of the final control element (or of the corresponding actuator) for the predefined time period. In this preferred example, the initial value is actual charge value 14 corrected by a weighted difference between actual charge value 14 and theoretically achievable charge value 15 in the maximum opening state, weighting factor 13 being a function of the opening dynamic of the final control element. Initial value 19 is thus a maximum charge achievable without charging effects only as a result of the dynamic of the final control element and of the air system.

In the second stage, the charge contribution from the charger system of the air system is ascertained. This ascertainment takes place as a function of the charging behavior of the air system ascertained in the first step as well as of the dynamic of the charge buildup by the charger for the predefined time period. The ascertainment takes place as a function of multiple or all of the following physical variables: (ascertained instantaneous) mass flow via a compressor, (ascertained instantaneous) pressure ratio at the compressor of the charger, (ascertained instantaneous) charging pressure, (ascertained instantaneous) intake manifold pressure, (ascertained instantaneous) engine speed, (ascertained instantaneous) ambient variables (in particular ambient pressure and ambient temperature).

FIG. 2 schematically shows one preferred method for predicting a maximally achievable cylinder charge. For this purpose, a value 36, which represents the charge additionally deliverable by the charger, is ascertained as a function of a starting value 39 as well as an engine speed 33 and a pressure ratio at the compressor of charger 34. The pressure ratio at the compressor of charger 34 is ascertained as the ratio between the pressure ratio upstream from the compressor and the pressure ratio downstream from the compressor. Starting value 39 is preferably the maximum charge which is output as an end value in the first stage and maximally achievable without charging effects only as a result of the dynamic of the final control element and of the air system, i.e., initial value 19 which represents the charging behavior of the air system for the predefined time period as a function of the dynamic of the final control element (or of the corresponding actuator). In step 21, this value 39 is preferably multiplied by a value which is a function of engine speed 33 and determines with the aid of an engine characteristics map as a function of the value ascertained in this way and of the pressure ratio at compressor 34 what charge difference is to be additionally expected from the charger during the observed time period. In this determination, or in this engine characteristic map, the dynamic of the charger during the time period determined for the prediction is thus contained. This may take place by the time value being fixedly applied, e.g., being based on the engine characteristic map, or by the time value being taken into account in a variable manner, e.g., the time value representing another dimension of the engine characteristic map.

In step 22, the charging behavior of the air system (in particular of the intake manifold and the charge air line) is ascertained as a function of charging pressure 31 and intake manifold pressure 32. This preferably takes place similarly to step 1 of FIG. 1, it being possible for step 22 to be based on another engine characteristic map than step 11 [sic; 1]. In step 23, corresponding value 37 is linked to value 36 (in particular by multiplication). In this way, the charge difference to be expected from the charger during the corresponding time period is weighted as a function of the charging behavior of the air system as well as of the dynamic of the final control element. Resulting value 39 is corrected in step 25 (in particular by multiplication) by a correction value 38. The latter was ascertained in step 24 as a function of ambient variables such as ambient pressure and ambient temperature. Corrected value 40 is linked in step 26 to a value 41 (in particular by addition) which represents the dynamic charging behavior of the air system and was preferably ascertained according to initial value 19 of FIG. 1. Thus, the charge additionally providable by the charging system during the observed time period is added to the charge achievable by the dynamic of the final control element and of the air system during the observed time period. Resulting value 42 thus represents a maximally achievable cylinder charge.

In step 27, this value 42 is still delimited by a maximum stationary cylinder charge 43. This maximum stationary cylinder charge 43 is predicted, for example, as that (theoretical) cylinder charge which results after an infinite waiting time when the instantaneous variables ambient pressure, ambient temperature, and speed are assumed to be constant, the throttle valve is completely opened, and the charger contributes at its maximum. This maximum stationary cylinder charge 43 is preferably also delimited, namely by the charge maximally admissible for the instantaneous state variables due to the component protection. The admissible cylinder charge is preferably determined as a function of an instantaneous speed as well as, if necessary, of other variables, e.g., inferred from a characteristic curve. Resulting value 44 thus corresponds to value 42 if the latter lies below maximally stationary (and thus maximally admissible) charge 43, and otherwise value 43 [sic].

The thus ascertained cylinder charge (capped by the maximally admissible cylinder charge) which is maximally achievable within a certain time period starting from the actual state of the combustion engine may then be converted into a maximally achievable torque, preferably as a function of an ignition angle efficiency and a lambda efficiency.

The maximally achievable torque thus ascertained may then be forwarded, for example, from the ascertaining engine control unit to another control unit. The value is preferably transferred to a transmission control unit. In this way, a transmission control unit of a dual-clutch transmission may, for example, control a switching operation in a considerably improved manner due to this provided variable. For a preferably optimal clutch operation, the transmission needs the information regarding what torque may maximally occur during the switching operation. The variables (a) instantaneously maximum stationary torque (computed on the basis of instantaneous state variables and under the assumption of maximally opened throttle valve and infinite waiting time) as well as (b) maximally admissible torque are suitable for this purpose only insufficiently. If the torque to be maximally expected is known, it is possible for the transmission to pre-tension the contact pressure in exactly such a way that this maximum torque is compensated for. If this is exactly the case, a fine transition may take place during the switching. On the basis of the often excessively high maximally admissible torque value, a clearly excessively high contact pressure would be provided, whereby jerking during the switching and a negative start-up behavior occurs.

In one preferred embodiment, a time period, which is a function of the time period of the control operation for which the variable is ascertained and transmitted to a control unit, is used to ascertain the maximally achievable torque. For example, the above-described switching operation lasts in the range between 100 ms and 1 s. In the case of a duration of 400 ms of one control operation, it is preferably to be ascertained, as the transmitting torque variable, what torque would be maximally achievable within a time period of 400 ms (provided that the maximally admissible torque was maintained) in the case of the full load requested at the present point in time.

What is claimed is:

1. A method for ascertaining a cylinder charge of an internal combustion engine of a vehicle achievable within a predefinable time period, comprising:
ascertaining a charging behavior of an air system, the air system including at least one of an intake manifold, and a charge air line of the combustion engine, the charging behavior being ascertained within the time period as a function of instantaneous operating variables of the internal combustion engine, and a value which characterizes a dynamic of a final control element of the air system, the final control element including a throttle valve; and
ascertaining the achievable cylinder charge within the time period as a function of the ascertained charging behavior of the air system, and as a function of a charge buildup by a charger of the internal combustion engine.

2. The method as recited in claim 1, wherein a torque which is achievable within the time period is ascertained as a function of the achievable cylinder charge via an ignition angle efficiency and a lambda efficiency.

3. The method as recited in claim 2, wherein the achievable torque is transmitted to a control unit of the vehicle which one of controls or regulates a function as a function of the achievable torque.

4. The method as recited in claim 3, wherein the time period is a function of time which is needed by the control unit for the control or regulation.

5. The method as recited in claim 1, wherein the charging behavior of the air system is ascertained as a function of a retardation due to an opening of the final control element.

6. The method as recited in claim 1, wherein the ascertainment of the charging behavior of the air system takes place as a function of an ascertained charging pressure and an ascertained intake manifold pressure.

7. The method as recited in claim 1, wherein the ascertainment of the charging behavior of the air system takes place as a function of a theoretical charge, when the final control element is completely opened, and of an ascertained instantaneous charge.

8. The method as recited in claim 1, wherein the charge buildup by the charger is ascertained as a function of an instantaneous compression ratio at the charger.

9. The method as recited in claim 1, wherein the charge buildup by the charger is ascertained as a function of at least one of an ascertained engine speed, an ambient pressure, and an ambient temperature.

10. The method as recited in claim 3, wherein the achievable torque is transmitted to a transmission control unit, the transmission control unit being a dual-clutch transmission.

11. The method as recited in claim 10, wherein the transmission control unit controls or regulates a switching operation as a function of the achievable torque.

12. The method as recited in claim 11, wherein the time period is a function of a time which is needed for a switching operation.

13. A computer-readable storage medium storing a computer program for ascertaining a cylinder charge of an internal combustion engine of a vehicle achievable within a predefinable time period, the computer program, when executed by a control unit, causing the control unit to perform:
ascertaining a charging behavior of an air system, the air system including at least one of an intake manifold, and a charge air line of the combustion engine, the charging behavior being ascertained within the time period as a function of instantaneous operating variables of the internal combustion engine, and a value which characterizes a dynamic of a final control element of the air system, the final control element including a throttle valve; and
ascertaining the achievable cylinder charge within the time period as a function of the ascertained charging behavior of the air system, and as a function of a charge buildup by a charger of the internal combustion engine.

14. An electronic storage medium storing a computer program for ascertaining a cylinder charge of an internal combustion engine of a vehicle achievable within a predefinable time period, the computer program, when executed by a control unit, causing the control unit to perform:
ascertaining a charging behavior of an air system, the air system including at least one of an intake manifold, and a charge air line of the combustion engine, the charging behavior being ascertained within the time period as a function of instantaneous operating variables of the internal combustion engine, of a value which characterizes a dynamic of a final control element of the air system, the final control element including a throttle valve; and
ascertaining the achievable cylinder charge within the time period as a function of the ascertained charging behavior of the air system, and as a function of a charge buildup by a charger of the internal combustion engine.

15. An electronic control unit to ascertain a cylinder charge of an internal combustion engine of a vehicle achievable within a predefinable time period, the electronic control unit configured to ascertain a charging behavior of an air system, the air system including at least one of an intake manifold, and a charge air line of the combustion engine, the charging behavior being ascertained within the time period as a function of instantaneous operating variables of the internal combustion engine, and of a value which characterizes a dynamic of a final control element of the air system, the final control element including a throttle valve, the electronic control unit being further configured to ascertain the achievable cylinder charge within the time period as a function of the ascertained charging behavior of the air system, and as a function of a charge buildup by a charger of the internal combustion engine.
